(19) United States
(12) Patent Application Publication
(10) Pub. No.: US 2026/0097693 A1
(43) Pub. Date: Apr. 9, 2026

(54) SEAT ASSEMBLY WITH IMPACT ABSORBER

(71) Applicant: LEAR CORPORATION, Southfield, MI (US)

(72) Inventors: Mario Lukacik, Plzen (CZ); Jaroslav Solc, Plzen (CZ)

(21) Appl. No.: 18/910,127

(22) Filed: Oct. 9, 2024

(51) Int. Cl. B60N 2/427; B60R 16/02

(52) U.S. Cl. CPC B60N 2/427; B60R 16/0215

(57) ABSTRACT

An assembly comprises a first seat structure, a second seat structure supported by the first seat structure, wherein the second seat structure includes a thoracic region, and a trim body positioned between the first seat structure and the second seat structure. The trim body comprises a plurality of discrete deformable portions, and wherein the trim body is spaced from the first seat structure by an open area at the thoracic region.

### BACKGROUND

A vehicle seat assembly includes a seat back that supports an upper body region of a seat occupant.

### BRIEF DESCRIPTION OF THE DRAWINGS

FIG. 1A is an inboard side view of an upper portion of a seat back with 50% of a hardback and 50% of foam being visible.

FIG. 1B is a rear view of the upper portion of the seat back of FIG. 1A.

FIG. 2A is an inboard side view of the upper portion of the seat back with the hardback removed and 50% of the foam being visible.

FIG. 2B is a rear view of the upper portion of the seat back of FIG. 2A.

FIG. 3A is a rear view of a trim body from the seat back of FIG. 1A

FIG. 3B is an inboard side view of the trim body of FIG. 3A.

FIG. 3C is a front side view of the trim body of FIG. 3A.

FIG. 3D is a magnified view of a portion of the trim body of FIG. 3A.

FIG. 4A is a rear view of the upper portion of a seat back with the hardback and foam removed.

FIG. 4B is an inboard side view of the upper portion of the seat back of FIG. 4A.

FIG. 4C is a front side view of the upper portion of the seat back of FIG. 4A.

FIG. 5 is a section view taken along 5-5 of FIG. 3A.

FIG. 6 is a section view taken along 6-6 of FIG. 3A.

FIG. 7 is a section view taken along 7-7 of FIG. 3A.

FIG. 8 is a side view, partially cut away, showing a fixation between the trim body and the hardback.

### DETAILED DESCRIPTION

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

“One or more” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

It should be understood that terms such as “about,” “substantially,” and “generally” are not intended to be boundaryless terms, and should be interpreted consistent with the way one skilled in the art would interpret those terms.

This disclosure relates to an impact absorber that is associated with a shoulder/head area of a seat structure, and comprises a trim structure with a plurality of pre-defined deformable areas designed to facilitate deformation and energy dissipation during a braking or impact event.

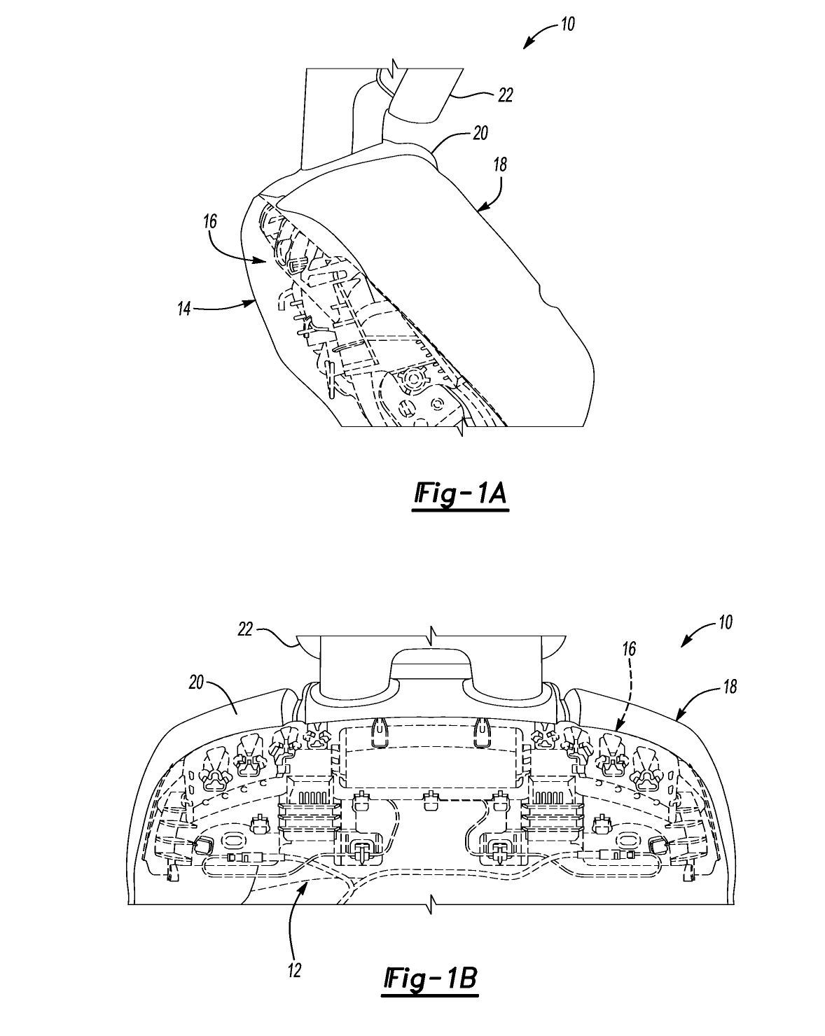

FIGS. 1A-1B show one example of a seat assembly 10 comprising a first seat structure 12, a second seat structure 14, and a trim body 16 positioned between the first seat structure 12 and the second seat structure 14. The seat assembly 10 may be utilized as a vehicle seat assembly 10 for seating in a vehicle, such as an automobile, an aircraft, a watercraft, or any other seating environment.

In one example, the first seat structure 12 comprises a seat frame component for a seat back 18. The seat frame may be comprised of one or more metal seat frame components such as one or more rigid bars and/or plates.

The second seat structure 14 is associated with, e.g., supported by, the first seat structure 12. In implementations, the second seat structure 14 includes a thoracic region comprising a region of the seat back 18 that aligns with a chest and upper back of an occupant, or otherwise aligns with a part of an occupant body between a neck and abdomen.

In one example, the second seat structure 14 comprises a hard back coupled to a seat back cushion comprised of foam 20 and supported by the first seat structure 12, e.g. one or more metal seat frame components. In one example, the hard back is comprised of a PC/ABS and PVC foil material. In other implementations, the second seat structure 14 may also comprise a soft back.

In one example, the second seat structure 14 at least partially encloses the first seat structure 12 and the trim body 16 within the seat back 18.

In one example, the seat assembly 10 may also include a head restraint 22 that may be configured to support the head of a seat occupant. The head restraint 22 may be disposed at the top of the seat back 18. The head restraint 22 may be unitary with the seat back 18 or may be a separate component that is adjustably positionable with respect to the top of the seat back 14. The seat assembly may also include a seat bottom (not shown) that is configured to support the seat occupant. In a vehicular application, the seat bottom may be mounted to a support surface, such as a vehicle floor (not shown). It should be understood that this is just one example of a seat configuration, and that other configurations could also be utilized.

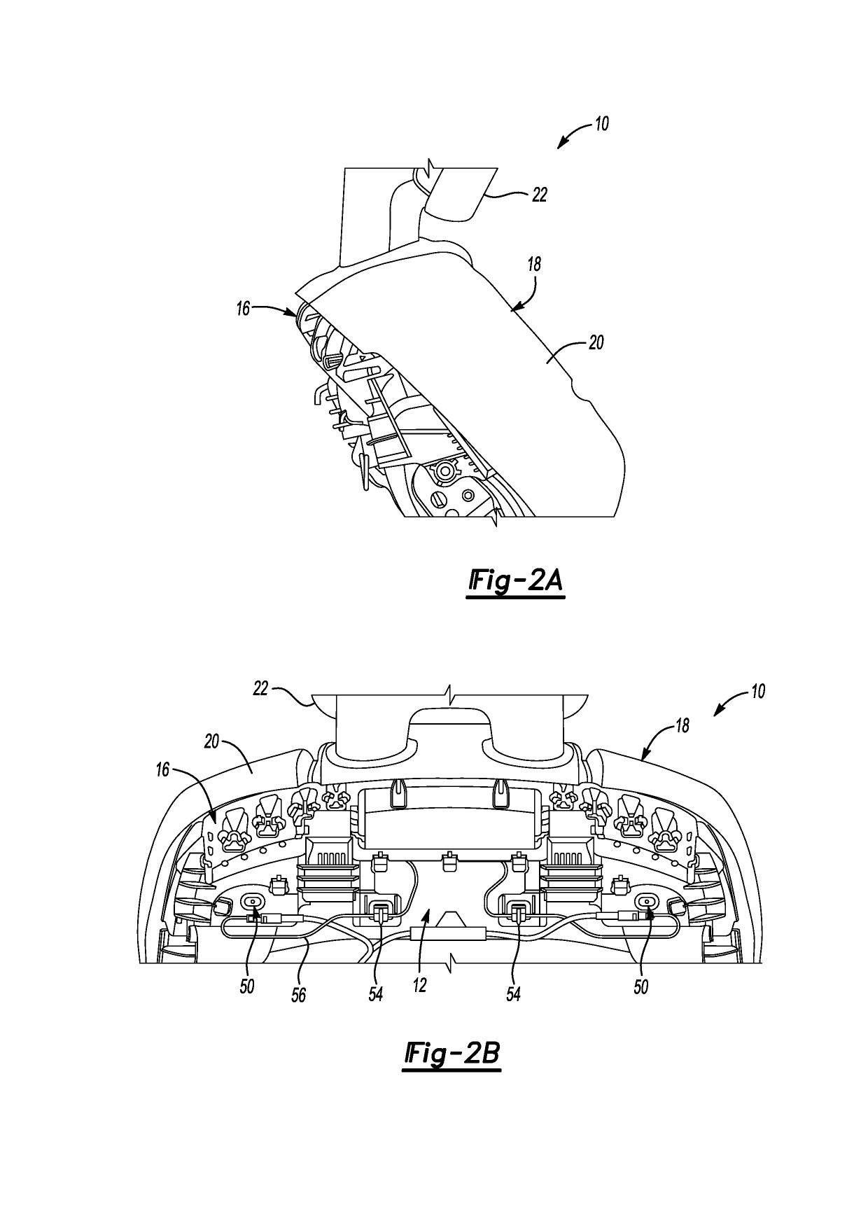

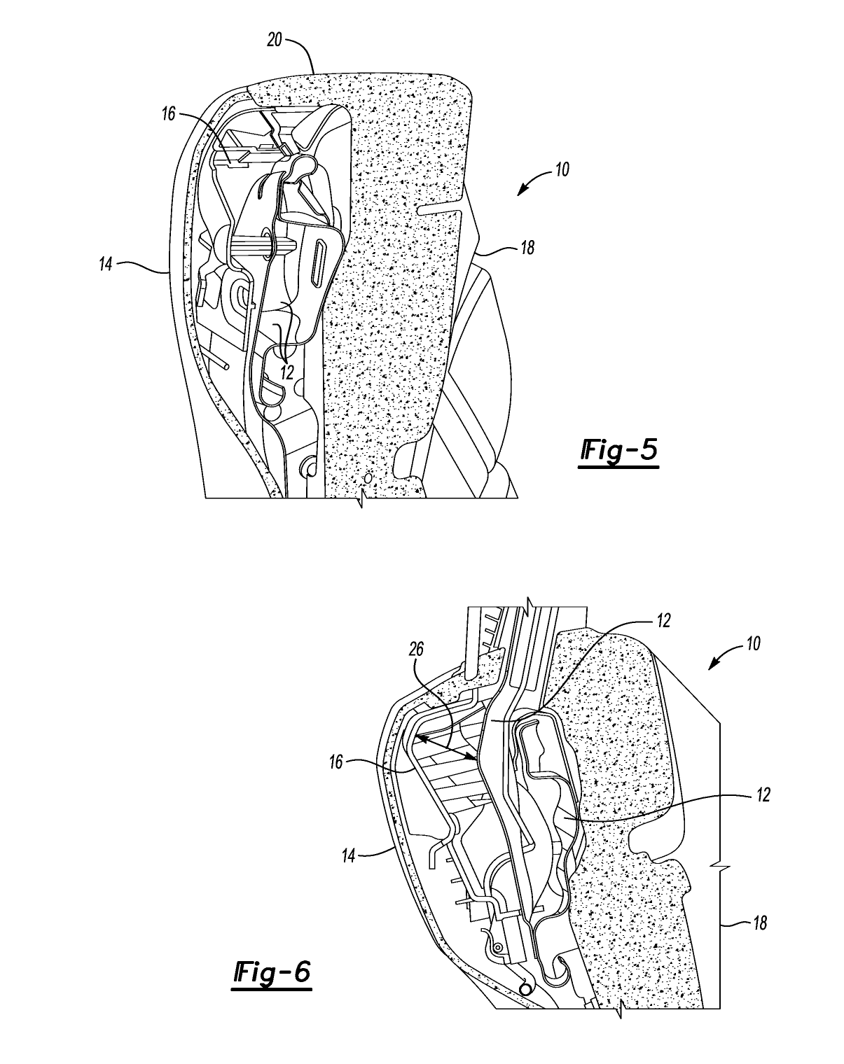

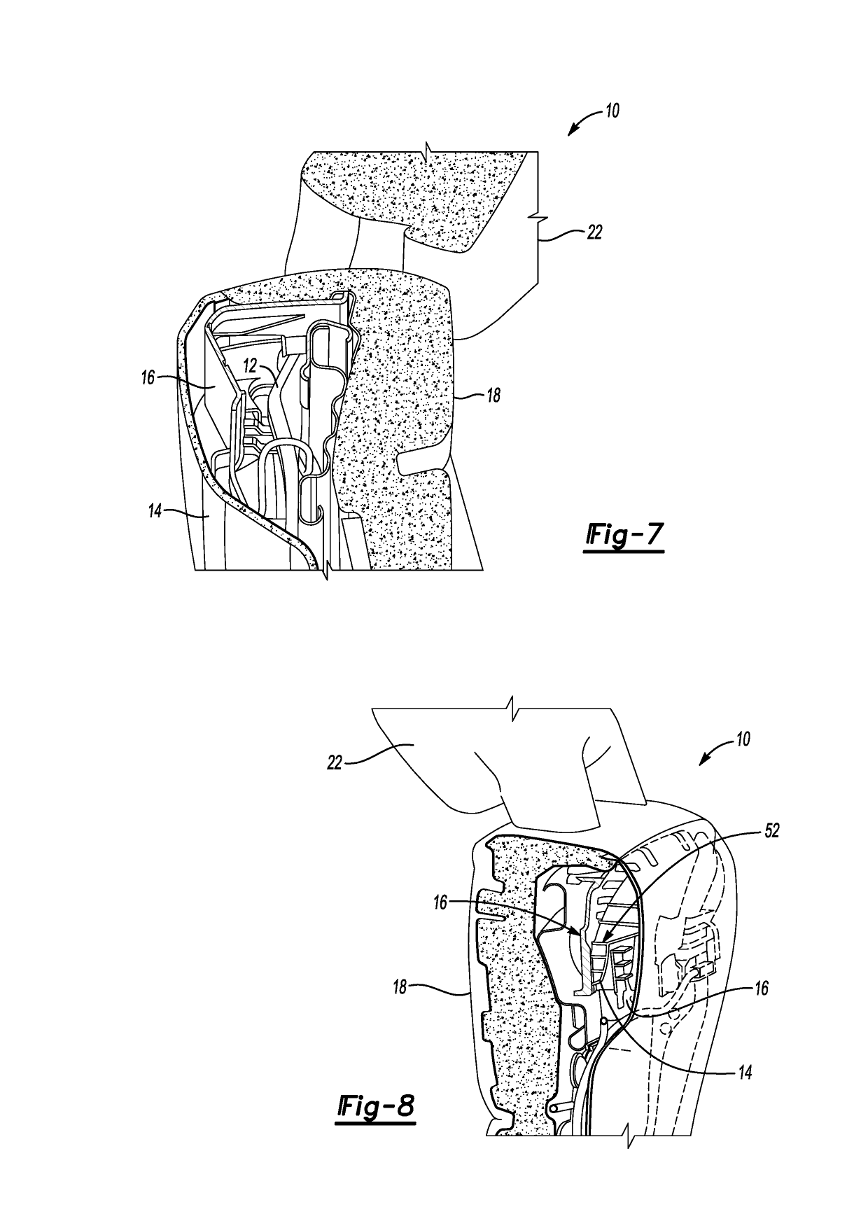

FIGS. 1A-B show an inboard side view of an upper portion of the seat back 18 with only 50% of the second seat structure 14, e.g., the hardback, and 50% of the foam 20 being visible such that a position of the trim body 16 in the seat assembly 10 can be more easily seen. FIGS. 2A-B are similar to FIGS. 1A-B but have the hardback removed and only have 50% of the foam 20 being visible. FIGS. 5-8 show the position of the trim body 16 in relation to the other seat components.

In implementations, the trim body 16 comprises a plastic structure or unit that includes a plurality of discrete deformable portions 24. In one example, the trim body 16 is spaced from the first seat structure 12 by an open area 26 (FIG. 6) at the thoracic region. In one example, the open area 26 comprises a free space defined as a minimum pre-determined distance between the first seat structure 12 and the trim body 16.

In one example, the plastic unit making up the trim body 16 comprises a single-piece or one-piece structure, e.g., monolithic structure. Any type of suitable plastic material may be used to form the upper trim list/body.

In one example, the plurality of discrete deformable portions 24 comprise slots/openings, trenches/grooves, and/or specially shaped openings/structures that comprise weakened areas to control deformation by absorbing impact energy in response to a braking or impact vehicle event.

In one example, the trim body 16 is positioned between a seat frame structure and foam in an upper seat region, and the trim body 16 is positioned between the hard back structure and the seat frame structure in a middle to lower seat region. In one example, foam wraps around the back and upper back of the seat frame structure.

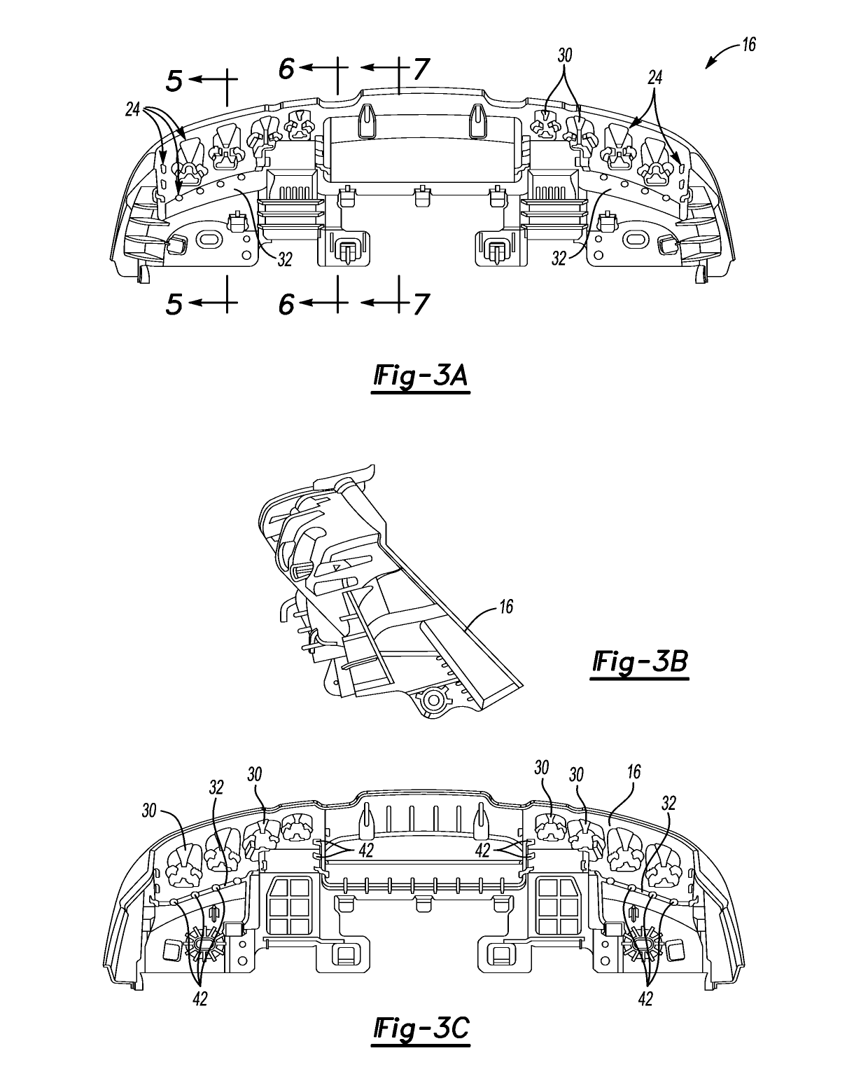

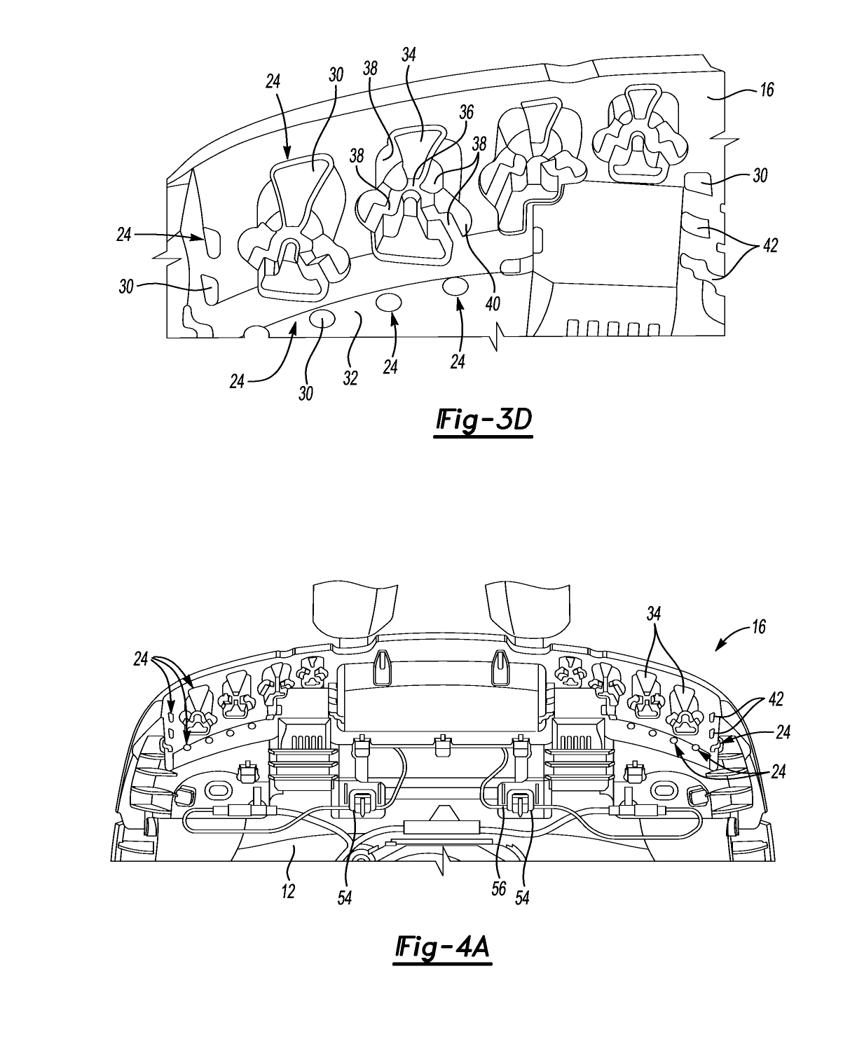

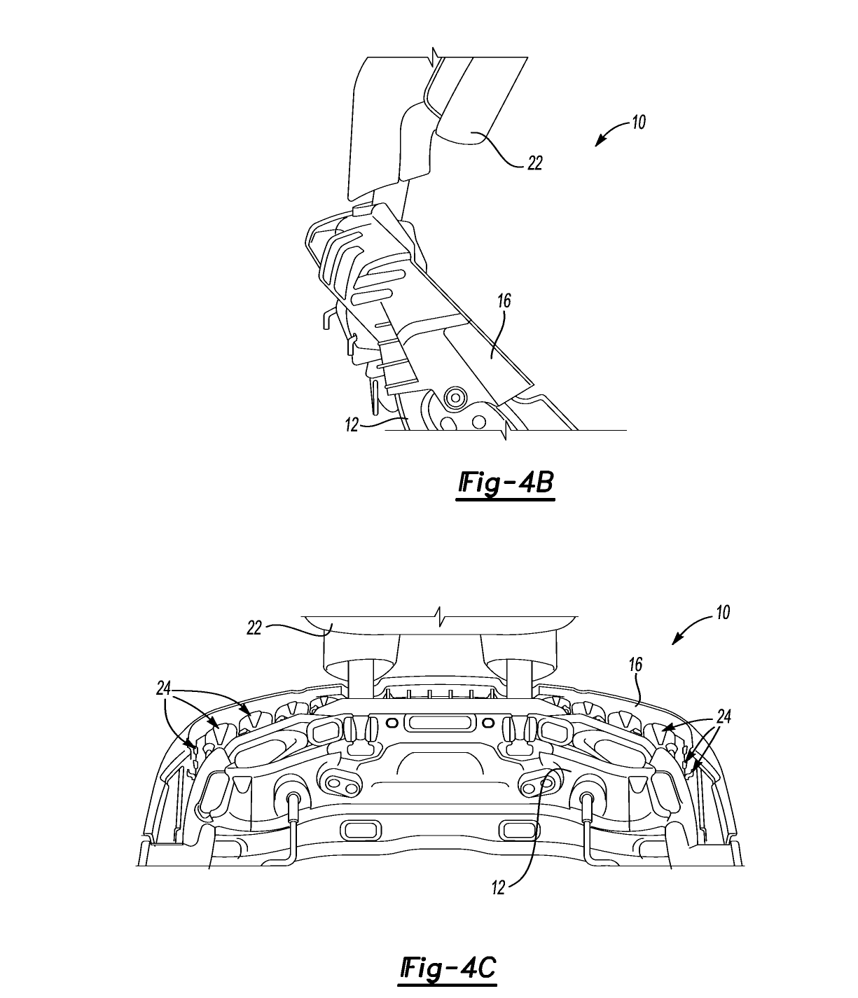

In implementations, the plurality of discrete deformable portions 24 comprise weakened areas such as openings, slots, and/or depressions of varying a thickness of the trim body 16 to form break lines/areas on the trim body 16. FIGS. 3A-D show different examples of the discrete deformable portions 24.

In implementations, the weakened areas comprise one or more openings 30. In one example, the openings 30 comprise apertures, holes, or slots that extend through an entire thickness of the trim body 16 at a designated area.

In implementations, the weakened areas comprise one or more trenches 32. In one example, the trenches 32 are formed as depressions that comprise reduced thickness portions of the trim body 16 at a designated area.

In one example, the trenches 32 comprise depressed channels forming break lines in pre-determined areas of the trim body 16.

In implementations, the openings 30 comprise at least two different types of openings 34, 42. In one example, the first type of opening 34 comprises a non-uniform shaped opening. In one example, a non-uniform shaped opening refers to an aperture or gap in a component that does not adhere to regular or symmetrical geometric patterns. Instead, a perimeter of this type of opening may vary in curvature, angles, or dimensions throughout its boundaries.

In implementations, a non-uniform shaped opening might include irregular boundaries, complex contours, or variable dimensions. An irregular boundary is defined by an outline of the opening and may comprise varying curves, angles, or combinations thereof, rather than following a predictable pattern like a circle, square, or rectangle for example. A complex contours is defined by edges of the opening and may feature complex contours that deviate from traditional geometric shapes, potentially incorporating curves, concavities, or convexities for example. Additionally, the dimensions of the opening may vary or change along a perimeter, resulting in areas of differing widths or lengths within the same opening.

In one example, each first type of opening 34 has a disc 36, e.g., a solid plate structure, centered within the opening 34 (FIG. 3D). In one example, the disc 36 is connected to the trim body 16 via one or more legs 38 that extend from the disc 36 to edges 40 of the opening 34. In one example, the legs 38 comprise deformable extensions that collapse during a hard braking or impact load event.

In implementations, the second type of opening 42 may comprise uniform openings that have a common shape and/or are formed as having the same size.

In one example, the second type of openings comprise openings 42 that are grouped together and extend along a pre-defined path. In one example, the pre-defined path comprises a linear path. In one example, the openings 42 are grouped together in a desired pattern in a designated area.

In implementations, the second type of opening 42 may be defined by an outer periphery that is smaller than an outer periphery of the first type of opening 34. For example, the second type of openings 42 may have a smaller open area than the first type of opening 34.

In implementations, the second type of openings 42 are aligned with the depressed channels 32. For example, at least some of the smaller uniform shaped openings 42 may follow the same path as the trenches 32.

In one example, the openings 34 and/or 42 may comprise an eggshell shape and comprise the breaking/deformation features, which are designed to reach a metal seat structure as soon as possible after an impact event with the intention to deform/break and dissipate energy quickly. Similarly, the break lines/slots/holes/trenches provide additional features that serve to coordinate breakage in response to an impact load and dissipate the associated kinetic energy.

In implementations, the trim body 16 may provide additional connection interfaces for other seat components. For example, the trim body 16 may include slots or openings 50 (FIG. 2B) that are configured to receive fasteners, retaining elements, or connectors from the first seat structure 12 and/or the second seat structure 14.

For example, the trim body 16 may include openings that receive hooks from the hard back 14 as shown a hard back attachment interface 52 in FIG. 8.

For example, the trim body 16 may include clips 54, e.g., tubular receptacles, that receive portions of a wire harness 56 as shown in FIG. 2B.

In implementations, the subject disclosure also provides for a method of dissipating impact energy in a seat assembly using an impact absorber that comprises a trim structure with a plurality of pre-defined deformable areas. In one example, the method includes forming a plastic trim body 16 to include a plurality of deformable portions 24 that comprise discrete weakened areas on the trim body 16. The trim body 16 is then positioned between a seat back frame 12 and a seat back outer component 14, e.g., a hard back or soft back coupled to a seat back cushion to enclose the seat back frame. The trim body 16 is located within a space between the seat back outer component and frame. In, response to an impact load, the trim body 16 breaks at the discrete weakened areas within the space to dissipate impact energy by absorbing energy in a controlled manner along the weakened areas.

In implementations, the free space between hard metal structure 12 and plastic trim parts 16 is essential for energy dissipation. This free space is needed to allow plastic part deformation before contacting of an occupant portion onto a harder seat structure.

The subject disclosure relates to an absorber comprising a unit made of plastic, and which is associated with a shoulder and/or head area of a seat structure. In implementations, the plastic unit includes special features which are designed to undergo deformation during an impact or collision and dissipate impact energy, thereby minimizing impact. As shown in the various figures, an upper trim region of the plastic unit comprises break lines and non-uniform shaped, e.g., eggshell shaped, cavities which are designed to undergo deformation in a controlled fashion during an impact or collision and dissipate impact energy. The plastic unit may be designed to engage with a seat back frame such that there is free space between hard metal structures and plastic trim parts. This free space may be needed to allow plastic part deformation before contact of a shoulder and/or head area onto harder structure. Thus, the subject disclosure serves two purposes: (1) absorb/dissipate impact energy during a braking event of a vehicle; and (2) assemble together or fixation of the hard back, the wire harness system, and the metal structure as a unit.

In implementations, an assembly comprises: a first seat structure; a second seat structure supported by the first seat structure, wherein the second seat structure includes a thoracic region; and a trim body positioned between the first seat structure and the second seat structure, the trim body comprising a plurality of discrete deformable portions, and wherein the trim body is spaced from the first seat structure by an open area at the thoracic region.

The assembly may include any of the following features either alone or in any combination thereof.

In one example, the trim body comprises a single-piece plastic component and including foam positioned between at least a portion of the trim body and the first seat structure.

In one example, the first seat structure comprises a seat frame comprised of one or more metal components.

In one example, the second seat structure comprises a hard back that at least partially encloses the seat frame and the trim body within a seat back.

In one example, the plurality of discrete deformable portions comprise weakened areas on the trim body.

In one example, the weakened areas comprise one or more openings and one or more trenches.

In one example, the one or more openings comprise a plurality openings, wherein each opening has a disc centered within the opening, and wherein the disc is connected to the trim body via one or more legs that extend from the disc to edges of the opening.

In one example, the one or more openings comprise a plurality of openings that are grouped together and extend along a pre-defined path.

In one example, the one or more trenches comprise depressed channels forming break lines in pre-determined areas of the trim body.

In one example, the trim body includes at least one of: slots that receive connectors from at least one of the first seat structure and the second seat structure; and clips that receive portions of a wire harness.

In implementations, an assembly comprises: a seat back frame; a seat back outer component supported by the seat back frame, wherein the seat back outer component includes a thoracic region; and a trim body positioned between the seat back frame and the seat back outer component, the trim body comprising a plurality of deformable portions that comprise discrete weakened areas on the trim body, and wherein the trim body is spaced from the seat back frame by an open area at the thoracic region.

In one example: the trim body comprises a single-piece plastic component with foam positioned between at least a portion of the trim body and the seat back frame; the seat back frame is comprised of one or more metal components; and the seat back outer component at least partially encloses the seat back frame and the trim body within a seat back.

In one example, the plurality of deformable portions comprise weakened areas on the trim body.

In one example, the weakened areas comprise at least: a first type of opening; a second type of opening different than the first type of opening; and one or more trenches.

In one example: the first type of opening comprises a plurality of non-uniform shaped openings, wherein each non-uniform shaped opening has a disc centered within the non-uniform shaped opening, and wherein the disc is connected to the trim body via one or more legs that extend from the disc to edges of the non-uniform shaped opening; the second type of opening comprises a plurality of uniform shaped openings that are grouped together and extend along a pre-defined path; and the one or more trenches comprise depressed channels forming break lines in pre-determined areas of the trim body.

In one example, the second type of opening is defined by an outer periphery that is smaller than an outer periphery of the first type of opening.

In one example, the plurality of uniform shaped openings are aligned with the depressed channels.

In implementations, a method comprises: forming a trim body to include a plurality of deformable portions that comprise discrete weakened areas on the trim body; positioning the trim body between a seat back frame and a seat back outer component associated with the seat back frame; spacing the trim body from the seat back outer component by an open area; and in response to an impact load, breaking the trim body at the discrete weakened areas to dissipate impact energy.

In one example, the method includes forming the discrete weakened areas as a plurality of different types of openings and grooves.

In one example, the method includes forming the trim body as a single-piece plastic component, forming the seat back frame from one or more metal components, and positioning foam between at least a portion of the trim body and the seat back frame.

Although the different examples have the specific components shown in the illustrations, embodiments of this disclosure are not limited to those particular combinations. It is possible to use some of the components or features from one of the examples in combination with features or components from another one of the examples. In addition, the various figures accompanying this disclosure are not necessarily to scale, and some features may be exaggerated or minimized to show certain details of a particular component or arrangement.

One of ordinary skill in this art would understand that the above-described embodiments are exemplary and non-limiting. That is, modifications of this disclosure would come within the scope of the claims. Accordingly, the following claims should be studied to determine their true scope and content.

1. An assembly comprising:
a first seat structure;
a second seat structure supported by the first seat structure, wherein the second seat structure includes a thoracic region; and
a trim body positioned between the first seat structure and the second seat structure, the trim body comprising a plurality of discrete deformable portions, and wherein the trim body is spaced from the first seat structure by an open area at the thoracic region.

2. The assembly of claim 1, wherein the trim body comprises a single-piece plastic component and including foam positioned between at least a portion of the trim body and the first seat structure.

3. The assembly of claim 1, wherein the first seat structure comprises a seat frame comprised of one or more metal components.

4. The assembly of claim 3, wherein the second seat structure comprises a hard back that at least partially encloses the seat frame and the trim body within a seat back.

5. The assembly of claim 1, wherein the plurality of discrete deformable portions comprise weakened areas on the trim body.

6. The assembly of claim 5, wherein the weakened areas comprise one or more openings and one or more trenches.

7. The assembly of claim 6, wherein the one or more openings comprise a plurality openings, wherein each opening has a disc centered within the opening, and wherein the disc is connected to the trim body via one or more legs that extend from the disc to edges of the opening.

8. The assembly of claim 6, wherein the one or more openings comprise a plurality of openings that are grouped together and extend along a pre-defined path.

9. The assembly of claim 6, wherein the one or more trenches comprise depressed channels forming break lines in pre-determined areas of the trim body.

10. The assembly of claim 1, wherein the trim body includes at least one of:
slots that receive connectors from at least one of the first seat structure and the second seat structure; and
clips that receive portions of a wire harness.

11. An assembly comprising:
a seat back frame;
a seat back outer component supported by the seat back frame, wherein the seat back outer component includes a thoracic region; and
a trim body positioned between the seat back frame and the seat back outer component, the trim body comprising a plurality of deformable portions that comprise discrete weakened areas on the trim body, and wherein the trim body is spaced from the seat back frame by an open area at the thoracic region.

12. The assembly of claim 11, wherein:
the trim body comprises a single-piece plastic component with foam positioned between at least a portion of the trim body and the seat back frame;
the seat back frame is comprised of one or more metal components; and
the seat back outer component at least partially encloses the seat back frame and the trim body within a seat back.

13. The assembly of claim 12, wherein the plurality of deformable portions comprise weakened areas on the trim body.

14. The assembly of claim 13, wherein the weakened areas comprise at least:
a first type of opening;
a second type of opening different than the first type of opening; and
one or more trenches.

15. The assembly of claim 14, wherein:
the first type of opening comprises a plurality of non-uniform shaped openings, wherein each non-uniform shaped opening has a disc centered within the non-uniform shaped opening, and wherein the disc is connected to the trim body via one or more legs that extend from the disc to edges of the non-uniform shaped opening;
the second type of opening comprises a plurality of uniform shaped openings that are grouped together and extend along a pre-defined path; and
the one or more trenches comprise depressed channels forming break lines in pre-determined areas of the trim body.

16. The assembly of claim 15, wherein the second type of opening is defined by an outer periphery that is smaller than an outer periphery of the first type of opening.

17. The assembly of claim 15, wherein the plurality of uniform shaped openings are aligned with the depressed channels.

18. A method comprising:
forming a trim body to include a plurality of deformable portions that comprise discrete weakened areas on the trim body;
positioning the trim body between a seat back frame and a seat back outer component associated with the seat back frame;
spacing the trim body from the seat back outer component by an open area; and
in response to an impact load, breaking the trim body at the discrete weakened areas to dissipate impact energy.

19. The method of claim 18, including forming the discrete weakened areas as a plurality of different types of openings and grooves.

20. The method of claim 18, including forming the trim body as a single-piece plastic component, forming the seat back frame from one or more metal components, and positioning foam between at least a portion of the trim body and the seat back frame.
